(19) United States
(12) Patent Application Publication
(10) Pub. No.: US 2005/0166147 A1
(43) Pub. Date: Jul. 28, 2005

(54) Produce Ripeness Enhancement

(76) Inventor: Russell L. Stein, Englewood Cliffs, NJ (US)

Correspondence Address: OPPEDAHL AND LARSON LLP, P O BOX 5068, DILLON, CO, 80435-5068, US

(21) Appl. No.: 10/905,080

(22) Filed: Dec. 14, 2004

Related U.S. Application Data
(60) Provisional application No. 60/481,954, filed on Jan. 26, 2004.
(60) Provisional application No. 60/521,473, filed on May 2, 2004.

(51) Int. Cl. A23L 1/22

(52) U.S. Cl. 715/700

(57) ABSTRACT

The present invention provides a method of distributing food ripening information to a user comprising the steps of 1. A method of distributing food ripening information to a user, comprising the steps of: (1) providing a user interface wherein the user interface is capable of generating a first signal, wherein the first signal is indicative of an identifier of a food identified with the identifier, wherein the identifier of the identified food is selected from the group consisting of UPC bar codes, SKU numbers, and PLU numbers; (2) providing a computer wherein the computer is adapted to receive the first signal or a signal representative of the first signal, wherein the computer comprises: (i) a database comprising data, wherein the data comprises ripening directions of the identified food corresponding to the identifier of the identified food, (ii) means for referencing the first signal with the database to provide the data comprising ripening directions of the identified food corresponding to the identifier of the identified food, (iii) means for generating a second signal comprising ripening directions of the identified food corresponding to the identifier of the identified food, and (iii) means for providing a second signal comprising the data comprising ripening directions of the identified food corresponding to the identifier of the identified food; (3) receiving the first signal or a signal representative of the first signal indicative of the identifier of the food identified with the identifier from the computer user; (4) referencing the first signal or a signal representative of the first signal with the database; (5) generating a second signal comprising ripening directions of the identified food corresponding to the identifier of the identified food; and (6) providing the second signal or signal representative of the second signal comprising ripening directions of the identified food corresponding to the identifier of the identified food to the user by electronic communication or written communication, thereby distributing food ripening information to a user.

### CROSS REFERENCE TO RELATED APPLICATIONS

This application claims the benefit of U.S. provisional application 60/481 954 filed on Jan. 26, 2004 and U.S. provisional application 60/521473 filed on May 2, 2004, both of which are incorporated herein by reference.

### BACKGROUND OF INVENTION

Those who purchase and cook food are often presented with problems of knowing how to tell when an item of produce is ripe, or knowing how to store or keep the item to ripen it. This problem has become bigger in recent years because recently there has been a profusion of fresh foods that now exists during off seasons.

What many have longed for is perfectly ripe produce, meat and fish. They want produce, for example, that has all the aroma, taste and flavor of perfectly fresh produce. There are currently two methods to achieve this: 1. Pay a top-quality restaurant-style distributor who can charge the price and have the volume to ripen the produce itself and then deliver when ready; or 2. Do it yourself. For many people, doing it yourself is difficult and awkward because one does not necessarily know how to ripen it properly.

Several methods and apparatuses are described in the prior art that are specifically designed for the purpose of ripening food. US Patents directed generally to controlled ripening of produce include “Method for storing fruit,” U.S. Pat. No. 3,333,967 issued in October 1976; “Fruit ripening ethylene gas storage and dispensing system and container therefore,” U.S. Pat. No. 5,316,178, issued in May 1994; “Method for controlling the ripening of fresh produce,” U.S. Pat. No. 5,028,443, issued in July 1991; “Apparatus for controlling the ripening of fresh produce,” U.S. Pat. No. 4,779,524, issued in October 1998; and “Method for accelerating fruit respiration,” U.S. Pat. No. 4,764,389, issued in August 1988. The latter shows, et alia, a ripening enclosure intended for use in the home of the consumer. However, ripening in the home is not easy to get right even with the use of the aforementioned methods and apparatuses. Still many consumers are not aware of how to ripen produce correctly. A system that addresses these concerns will greatly improve the quality and joy people take from their food.

Applicant is not aware of any system like that of the present invention. The present invention has been developed to link the distribution of food along with the distribution of instructions and directions relating to how to ripen or store the food.

### SUMMARY OF INVENTION

Applicants have discovered a superior process for the distribution of food using the method of the present invention. In accordance with an embodiment of the present invention a method for distributing food and ripening directions thereof to a user comprises the steps of:
(1) providing a user interface wherein the user interface is capable of generating a first signal, wherein the first signal is indicative of an identifier of a food identified with the identifier, wherein the identifier of the identified food is selected from the group consisting of UPC bar codes, SKU numbers, and PLU numbers;
(2) providing a computer wherein the computer is adapted to receive the first signal or a signal representative of the first signal, wherein the computer comprises:
   (i) a database comprising data, wherein the data comprises ripening directions of the identified food corresponding to the identifier of the identified food,
   (ii) means for referencing the first signal with the database to provide the data comprising ripening directions of the identified food corresponding to the identifier of the identified food,
   (iii) means for generating a second signal comprising ripening directions of the identified food corresponding to the identifier of the identified food, and
   (iii) means for providing a second signal comprising the data comprising ripening directions of the identified food corresponding to the identifier of the identified food;
(3) receiving the first signal or a signal representative of the first signal indicative of the identifier of the food identified with the identifier from the computer user;
(4) referencing the first signal or a signal representative of the first signal with the database;
(5) generating a second signal comprising ripening directions of the identified food corresponding to the identifier of the identified food; and
(6) providing the second signal or signal representative of the second signal comprising ripening directions of the identified food corresponding to the identifier of the identified food to the user by electronic communication or written communication,
   thereby distributing food ripening information to a user.

### BRIEF DESCRIPTION OF THE DRAWING

FIG. 1 shows an embodiment of the invention.

### DETAILED DESCRIPTION OF THE INVENTION

This document describes a number of embodiments of an invention which identifies fruits and vegetables and uses that identifier to disseminate ripening information to preparers and consumers of fruits and vegetables.

One embodiment of this invention connects a database of fruit or vegetables (using, for example, UPC bar codes SKU numbers, or PLU (price lookup) numbers to identify the food) to a database that describes and then directs how the preparer or consumer could best ripen the product for consumption. This ripening direction could be in the form of written, electronic, or other instruction. One embodiment of the instruction would be as a sticker, similar to SKU or bar code stickers which is placed on the produce and describes ripening methods.

The invention provides directions as to how to ripen a particular type of produce. For example, for bananas the invention might say, to best ripen bananas, place in brown paper bag (to trap gas emissions) and keep at room temperature. Although direct sunlight and heat will accelerate ripening, shade is preferable for uniform ripening. Do not freeze or refrigerate prior to ripening (as this may inactivate critical enzymes required for ripening).

In many grocery stores, the produce are marked with “PLU” numbers (price lookup) which are used at the cash register to figure out what the price is. In this way the pricing is done differently than for most other stock-keeping-unit (SKU) systems and uniform product code (UPC) bar codes. See http://www.wired.com/news/medtech/0,1286,60911,00.html for more about PLUs.

In one embodiment of the invention, a system is provided which links the merchandising of the item (display, and sale) with a system that disseminates storage and ripening information.

For example, an embodiment of this is a tearcard next to each and every item in a store that either ripens or spoils and advises how best to prepare it for eating. Another embodiment is a checkout system that links the PLU number of each item at a register with a printout (on the receipt for example) that suggests storage and ripening techniques for each food item. Another embodiment would be a link between the sale of the item and an email to purchaser suggesting storage or ripening techniques.

An embodiment which is related is simply a computer database where the input is the identifier of the item (name, PLU etc) and the output is ripening and storage information. For example, an internet site may be provided where one could type the name of item (or, better, the PLU from a sticker on the item) and the site would sort and deliver suggested ripening or storage information. The website will preferably test to see whether a visiting browser is WAP (wireless application protocol) compatible, in the event of which the ripening or storage information is provided to the visiting browser in WAP format. In this connection it should be borne in mind that a WAP-equipped wireless telephone is well suited to the purpose. The user can browse to the website of the invention, key in the PLU using the telephone's numeric keypad, and receive the ripening/storage information.

Another embodiment is a system which suggests a method to delay ripening or create certain ripening effects. For example, an embodiment is a computer system that suggests for higher starch content, potatoes should be stored the dark at temperatures over 40 degrees Fahrenheit. However, for higher sugar content and better browning, storage at colder temperatures is recommended.

It will be appreciated that the invention easily extends to other foods such as meat, fish and poultry. Again, the system suggests mechanisms to delay spoilage (e.g. keep fish on a bed of ice on the lowest shelf furthest to the back wall of one's refrigerator). The system could also suggest mechanisms to further ripen animal foods such as methods to dry-age beef.

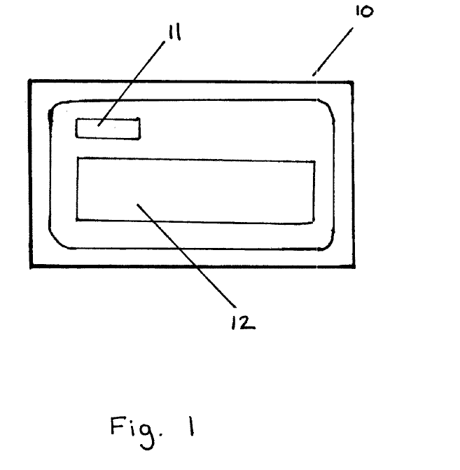

FIG. 1 shows an embodiment of the invention. Computer 10 has a screen with an entry area 11. The user picks up an item of produce which has a PLU (price lookup) number on a sticker on the item. The PLU number is entered into the screen at entry area 11. The computer 10 displays information in area 12 indicative of ripening and storage information.

1. A method of distributing food ripening information to a user, comprising the steps of:
(1) providing a user interface wherein the user interface is capable of generating a first signal, wherein the first signal is indicative of an identifier of a food identified with the identifier, wherein the identifier of the identified food is selected from the group consisting of UPC bar codes, SKU numbers, and PLU numbers;
(2) providing a computer wherein the computer is adapted to receive the first signal or a signal representative of the first signal, wherein the computer comprises:
(i) a database comprising data, wherein the data comprises ripening directions of the identified food corresponding to the identifier of the identified food,
(ii) means for referencing the first signal with the database to provide the data comprising ripening directions of the identified food corresponding to the identifier of the identified food,
(iii) means for generating a second signal comprising ripening directions of the identified food corresponding to the identifier of the identified food, and
(iii) means for providing a second signal comprising the data comprising ripening directions of the identified food corresponding to the identifier of the identified food;
(3) receiving the first signal or a signal representative of the first signal indicative of the identifier of the food identified with the identifier from the computer user;
(4) referencing the first signal or a signal representative of the first signal with the database;
(5) generating a second signal comprising ripening directions of the identified food corresponding to the identifier of the identified food; and
(6) providing the second signal or signal representative of the second signal comprising ripening directions of the identified food corresponding to the identifier of the identified food to the user by electronic communication or written communication,
thereby distributing food ripening information to a user.

2. The method of claim 1, wherein steps (1), (2), (3), (4), (5) and (6) are accomplished at a single location using a food ripening information distribution system comprising the user interface, the computer, and the means for providing the data of the second signal comprising ripening directions of the identified food corresponding to the identifier of the identified food to the user.

3. The method of claim 2, wherein the means for providing the data of the second signal comprising ripening directions of the identified food corresponding to the identifier of the identified food to the user is a printer, wherein the printer prints the data of the second signal onto a sticker or handout.

4. The method of claim 1, wherein the data further comprises delayed ripening directions, directions to create certain ripening characteristics, or both.

5. The method of claim 1, wherein the data further comprises storage directions specific to the identified food.

6. A method of distributing food ripening information to a computer user online, comprising the steps of:
(1) providing an online website wherein the website is adapted to receive a first signal from a computer user indicative of an identifier of a food identified with the identifier, wherein the identifier of the identified food is selected from the group consisting of UPC bar codes, SKU numbers, and PLU numbers, and wherein the online website comprises:
(i) a database comprising data, wherein the data comprises ripening directions of the identified food corresponding to the identifier of the identified food,
(ii) means for referencing the first signal with the database to provide the data comprising ripening directions of the identified food corresponding to the identifier of the identified food,
(iii) means for generating a second signal comprising ripening directions of the identified food corresponding to the identifier of the identified food, and
(iii) means for providing a second signal comprising the data comprising ripening directions of the identified food corresponding to the identifier of the identified food;
(2) receiving the first signal or a signal representative of the first signal indicative of the identifier of the food identified with the identifier from the computer user;
(3) referencing the first signal or a signal representative of the first signal with the database;
(4) generating a second signal comprising ripening directions of the identified food corresponding to the identifier of the identified food; and
(5) providing the second signal or signal representative of the second signal comprising ripening directions of the identified food corresponding to the identifier of the identified food to the computer user by electronic communication;
thereby distributing food ripening information to a computer user online.

7. The method of claim 6, wherein step (5) is accomplished by the use of an email to the computer user which provides the data to the computer user.

8. The method of claim 6, further comprising the step wherein the online website performs a test to see whether the computer user is WAP compatible, in the event of which the data is provided to the computer user in WAP format.

9. A food ripening information distribution system, comprising:
(1) a user interface adapted to receive input indicative of an identifier of a food identified with the identifier, wherein the identifier of the identified food is selected from the group consisting of UPC bar codes, SKU numbers, and PLU numbers, and wherein the user interface is adapted to generate and generates a first signal indicative of the identifier of the identified food;
(2) a computer adapted to receive and which receives the first signal or a signal representative of the first signal, and wherein the computer comprises:
(i) a database comprising data, wherein the data comprises ripening directions of the identified food corresponding to the identifier of the identified food, and
(ii) means for referencing the first signal with the database to provide the data comprising ripening directions of the identified food corresponding to the identifier of the identified food,
wherein the computer provides a second signal indicative of the data comprising ripening directions of the identified food corresponding to the identifier of the identified food; and
(3) a display means capable of receiving the second signal or a signal representative of the second signal, wherein the display means is capable of displaying the data comprising ripening directions of the identified food corresponding to the identifier of the identified food in the form of written communication or electronic communication.

10. The system of claim 9, wherein the user interface is selected from the group consisting of:
(1) a scanner adapted to scan the identifier of the identified food;
(2) a keyboard, wherein the user may input information indicative of the identifier of the identified food;
(3) a touch-screen selection system wherein the user may input information indicative of the identifier of the identified food; and
(4) a voice-recognition selection system wherein the user may input information indicative of the identifier of the identified food.

11. The system of claim 9, wherein the display means capable of receiving the second signal or signal representative of the second signal is a monitor.

12. The system of claim 9, wherein the display means capable of receiving the second signal is a printer.

13. The system of claim 9, wherein the user interface, the computer, and the display means are contained at a single location located in proximity to the site of the distribution of the food identified with the identifier.

14. An online food ripening information distribution system comprising:
(1) means for generating a first signal from a computer user indicative of an identifier of a food identified with the identifier, wherein the identifier of the identified food is selected from the group consisting of UPC bar codes, SKU numbers, and PLU numbers;
(2) an online website adapted to receive and receives the first signal or a signal representative of the first signal, wherein the online website comprises:
(i) a database comprising data, wherein the data comprises ripening directions of the identified food corresponding to the identifier of the identified food, and
(ii) means for referencing the first signal with the database to provide the data comprising ripening directions of the identified food corresponding to the identifier of the identified food,
wherein the online website is adapted to generate and generates a second signal indicative of the data comprising ripening directions of the identified food corresponding to the identifier of the identified food; and
(3) means for providing the second signal or signal representative of the second signal comprising ripening directions of the identified food corresponding to the identifier of the identified food to the computer user by electronic communication.

15. The system of claim 14, wherein the means for providing the second signal or signal representative of the second signal to the computer user is accomplished by the use of an email to the computer user which provides the data to the computer user.

16. The system of claim 14, wherein the online website further comprises means for performing a test to determine whether the computer user is WAP compatible, in the event of which the means for providing the second signal or signal representative of the second signal to the computer user is accomplished by providing the signal in WAP format.

17. An online food ripening information distribution website, wherein the website is adapted to receive and receives a first signal from a computer user indicative of an identifier of a food identified with the identifier, wherein the identifier of the identified food is selected from the group consisting of UPC bar codes, SKU numbers, and PLU numbers, and wherein the computer user provides the first signal indicative of the identifier of the identified food to the online website, wherein the online website comprises:
(1) a database comprising data, wherein the data comprises ripening directions of the identified food corresponding to the identifier of the identified food;
(2) means for referencing the first signal with the database to provide the data comprising ripening directions of the identified food corresponding to the identifier of the identified food,
wherein the online website generates a second signal indicative of the data comprising ripening directions of the identified food corresponding to the identifier of the identified food; and
(3) means for providing the second signal or signal representative of the second signal comprising ripening directions of the identified food corresponding to the identifier of the identified food to the computer user by electronic communication.

18. The system of claim 17, wherein the means for providing the second signal or signal representative of the second signal to the computer user is accomplished by the use of an email to the computer user which provides the data to the computer user.

19. The system of claim 17, wherein the online website further comprises means for performing a test to determine whether the computer user is WAP compatible, in the event of which the means for providing the second signal or signal representative of the second signal to the computer user is accomplished by providing the signal in WAP format.
